(19) United States
(12) Patent Application Publication
(10) Pub. No.: US 2012/0291295 A1
(43) Pub. Date: Nov. 22, 2012

(54) RAZOR WITH ROTATING AND LOCKING HEAD

(76) Inventor: Richard Thomas Braun, Panama City Beach, FL (US)

(21) Appl. No.: 13/111,549

(22) Filed: May 19, 2011

(51) Int. Cl. B26B 21/52

(52) U.S. Cl. 30/531

(57) ABSTRACT

In one aspect of the present invention, a razor has a handle, a razor cartridge, and an engaging mechanism having a first engaging member secured to the handle and a second engaging member secured to the razor cartridge. Each of the first and second engaging members has a surface and a structural pattern formed thereon. The structural pattern on the surface of the first engaging member is substantially complementary to the structural pattern on the surface of the second engaging member. As assembled, the surface of the first engaging member is in substantial contact with the surface of the second engaging member such that the structural pattern on the surface of the first engaging member and the structural pattern on the surface of the second engaging member are complementarily and mutually engaged so as to lock the first engaging member to the second engaging member, and the razor cartridge is aligned with the handle in an angle, β.

### FIELD OF THE INVENTION

The present invention relates generally to a razor, and more particularly to a razor having a handle, a head that includes a cartridge, and an engaging mechanism for engaging the head with the handle, where the engaging mechanism is configured such that the head is adjustably aligned with the handle at any desired angle.

### BACKGROUND OF THE INVENTION

Razors capable of shaving hairs on body parts of a user are well-known. Conventionally, a razor has a handle designed to be held in a user's hand and a razor head affixed at one end of the handle that includes a cartridge with one or more transversely extending blades. While the conventional razor is a popular device for shaving hairs on the face of a user, it permits shaving only in one direction substantially the same as the direction of the handle.

However, the conventional razor may not function effectively for removing unwanted hairs on other body parts, such as the back, head, legs, and so on, since such the design of the conventional razor does not allow access to these body parts by the user without operating the razor at very difficult and/or dangerous angles.

In addition, it is desired for a user to have a razor that allows doing custom designs in facial or scalp area or any other areas of the body.

Therefore, a heretofore unaddressed need exists in the art to address the aforementioned deficiencies and inadequacies.

### SUMMARY OF THE INVENTION

The present invention, in one aspect, relates to a razor. In one embodiment, the razor includes a handle, a razor head that includes a cartridge, and an engaging mechanism having a first engaging member secured to the handle and a second engaging member secured to the razor head. Each of the first and second engaging members has a surface and a structural pattern formed thereon, where the structural pattern on the surface of the first engaging member is substantially complementary to the structural pattern on the surface of the second engaging member.

In one embodiment, the structural pattern on the surface of the first engaging member comprises a plurality of protrusions, and the structural pattern on the surface of the second engaging member comprises a plurality of recesses complementarily corresponding to the plurality of protrusions on the surface of the first member, and vice versa. In another embodiment, each of the structural patterns on the surfaces of the first and second engaging members comprises a plurality of ribs spatially and radially arranged to define a saw-tooth profile circumferentially, wherein the saw-tooth profile on the surface of the first engaging member is substantially complementary to the saw-tooth profile on the surface of the second member.

As assembled, the surface of the first engaging member is in substantial contact with the surface of the second engaging member such that the structural pattern on the surface of the first engaging member and the structural pattern on the surface of the second engaging member are complementarily and mutually engaged so as to lock the first engaging member to the second engaging member, and the razor head is aligned with the handle in an angle, β. In one embodiment, the angle β is adjustable between 0 degree and 360 degrees by rotatably adjusting one of the first and second engaging members relative to the other of the first and second engaging members.

In one embodiment, each of the first and second engaging members of the engaging mechanism defines an opening in the center thereof. In one embodiment, the engaging mechanism further includes a spring member placed between the first and second engaging members through the openings to urge the structural patterns on the surfaces of the first and second engaging members substantially in a complementary engagement with one another. In another embodiment, the engaging mechanism further includes a screw member placed between the first and second engaging members through the openings to urge the structural patterns on the surfaces of the first and second engaging members substantially in a complementary engagement with one another.

In one embodiment, the razor head includes a razor cartridge body mechanically attached as is well-known in the art and an arm having a first end secured to the razor cartridge body and an opposite, second end secured to the second engaging member of the engaging mechanism. The razor cartridge body is comprised of one or more blades. As noted above, these blades are of uniform lengths, e.g., ¼ inch blades, ⅜ inch blades, or 1 inch blades.

In one embodiment, the handle and the first engaging member of the engaging mechanism are integrally formed, and the arm of the razor head and the second engaging member of the engaging mechanism are integrally formed.

In one embodiment, the razor has a handle having a first engaging member formed in one end thereof, and a head with a cartridge having a razor cartridge body, a second engaging member and an arm formed between the head and the second engaging member, where the razor cartridge body is comprised or one or more blades of uniform lengths, e.g., ¼ inch blades, ⅜ inch blades, or 1 inch blades. Each of the first and second engaging members has a surface and a structural pattern formed thereon. The structural pattern on the surface of the first engaging member is substantially complementary to the structural pattern on the surface of the second engaging member. In one embodiment, each of the first and second engaging members defines an opening in the center thereof.

As assembled, the surface of the first engaging member is in substantial contact with the surface of the second engaging member such that the structural pattern on the surface of the first engaging member and the structural pattern on the surface of the second engaging member are complementarily and mutually engaged so as to lock the first engaging member to the second engaging member, and the arm of the razor cartridge is aligned with the handle in an angle, β. In one embodiment, the angle β is adjustable between 0 degree and 360 degrees by rotatably adjusting one of the first and second engaging members relative to the other of the first and second engaging members.

In one embodiment, the razor further has a spring member placed between the first and second engaging members through the openings to urge the structural patterns on the surfaces of the first and second engaging members substantially in a complementary engagement with one another. In another embodiment, the razor further has a screw member placed between the first and second engaging members through the openings to urge the structural patterns on the surfaces of the first and second engaging members substantially in a complementary engagement with one another.

In one embodiment, the structural pattern on the surface of the first engaging member comprises a plurality of protrusions, and the structural pattern on the surface of the second engaging member comprises a plurality of recesses complementarily corresponding to the plurality of protrusions on the surface of the first member, and vice versa. In another embodiment, each of the structural patterns on the surfaces of the first and second engaging members comprises a plurality of ribs spatially and radially arranged to define a saw-tooth profile circumferentially, wherein the saw-tooth profile on the surface of the first engaging member is substantially complementary to the saw-tooth profile on the surface of the second member.

These and other aspects of the present invention will become apparent from the following description of a preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 shows schematically a perspective view of a razor according to one embodiment of the present invention;

FIGS. 2A-2C show schematically perspective views of the razor shown in FIG. 1 in exemplary angled configurations;

FIG. 3 shows schematically an exploded view of the razor shown in FIG. 1;

FIG. 4 shows schematically an another view of the razor shown in FIG. 1;

FIG. 5 shows schematically a partially perspective view of the razor shown in FIG. 1;

FIG. 6 shows schematically a partially perspective view of a razor according to another embodiment of the present invention; and

FIG. 7 shows schematically a perspective view of a razor according to yet another embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

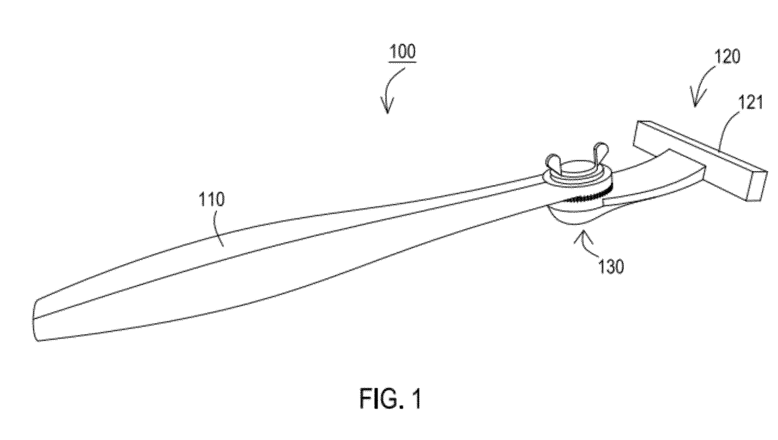

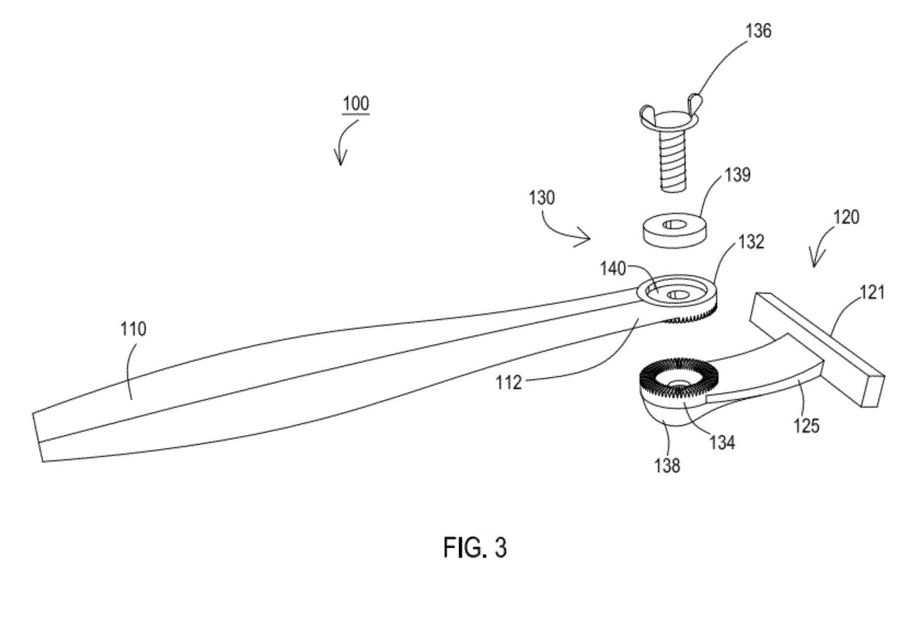

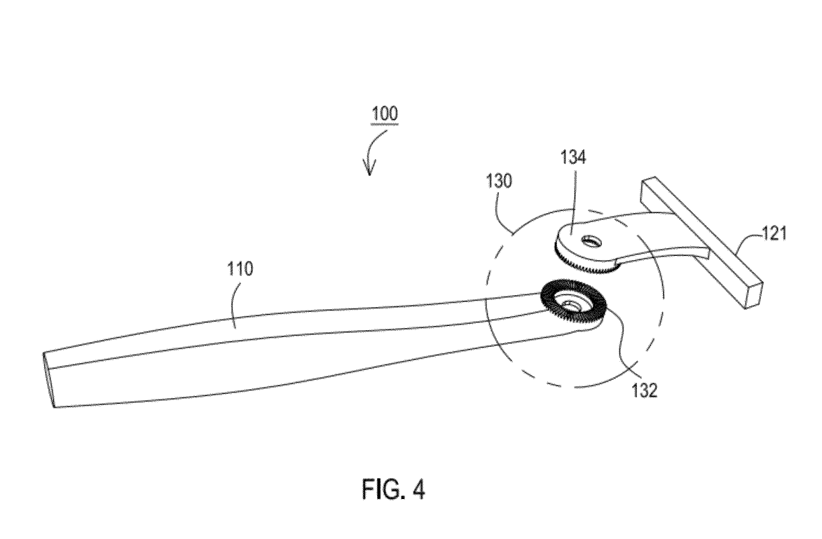

The description will be made as to embodiments of the present invention in conjunction with the accompanying drawings in FIGS. 1-7. In accordance with the purposes of this invention, as embodied and broadly described herein, this invention, in one aspect, relates to a razor. One of the proprietary features of the razor is a handle and a razor head/frame, that includes a cartridge, configured to allow the blade surface to rotate on the axis perpendicular to the handle so as to allow the user to ergonomically control the shaving motion and direction of the blades. According to the invention, when used, the razor head and its corresponding cartridge is rotated at a desired angle that is between 0-360 degrees relative to the handle and then locked into place allowing the user to shave back of head, under arms, back of legs, neck/face, without having to hold arms at odd angles.

Referring to FIGS. 1-5, a razor 100 is shown according to one embodiment of the present invention. The razor 100 includes a handle 110, a razor head 120 that includes a cartridge comprised of one or more blades described more fully below, and an engaging mechanism 130 having a first engaging member 132 secured to the handle 110 and a second engaging member 134 secured to the razor head 120. The razor head 120 has a razor cartridge body 121 and an arm 125 having a first end secured to the razor cartridge body 121 and an opposite, second end secured to the second engaging member 134 of the engaging mechanism 130. The razor cartridge body 121 is composed of one or more blades. One of ordinary skill in the art would recognize that the cartridge can be comprised of one or more blades with any desired width, such as ¼ inch, ⅜ inch, ¾ inch or 1 inch, depending upon the application.

In this exemplary embodiment, the first engaging member 132 of the engaging mechanism 130 is integrally formed with the handle 110 at its one end 112, while the second engaging member 134 of the engaging mechanism 130 is integrally formed with the arm 125 of the razor head 120 at the second end of the arm 125.

Each of the first and second engaging members 132 and 134 has a surface and a structural pattern 131/137 formed thereon. The structural pattern 131 on the surface of the first engaging member 132 is substantially complementary to the structural pattern 137 on the surface of the second engaging member 134.

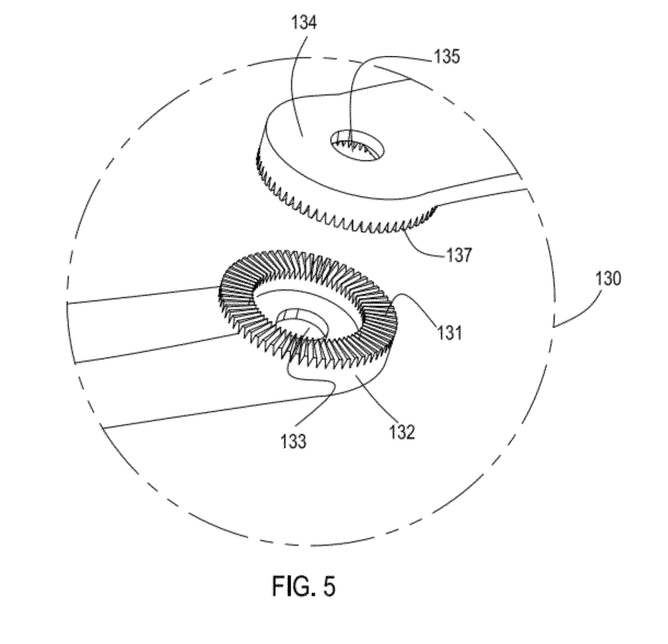

As clearly shown in FIG. 5, for example, each of the structural patterns 131/137 on the surfaces of the first and second engaging members 132 and 134 has a plurality of ribs spatially and radially arranged to define a saw-tooth profile circumferentially. The saw-tooth profile on the surface of the first engaging member 132 is substantially complementary to the saw-tooth profile on the surface of the second member 134.

Additionally, each of the first and second engaging members 132 and 134 of the engaging mechanism 130 defines an opening 133/135 in the center thereof.

As assembled, the arm 125 of the razor head 120 is aligned with the handle 110 at a desired angle, β, and the surface of the first engaging member 132 is in substantial contact with the surface of the second engaging member 134, so that the structural pattern 131 on the surface of the first engaging member 132 and the structural pattern 137 on the surface of the second engaging member 134 are complementarily and mutually engaged. In this exemplary embodiment, a screw member 136, grommet 139 and a nut member 138, integrally formed in the second engaging member 134, are used to lock the first engaging member 132 to the second engaging member 134 through the openings 133 and 135 of the first and second engaging members 132 and 134 to urge the structural patterns 131 and 137 on the surfaces of the first and second engaging members 132 and 134 substantially in a complementary engagement with one another. Other locking members, such as a spring, can also be employed to practice the present invention.

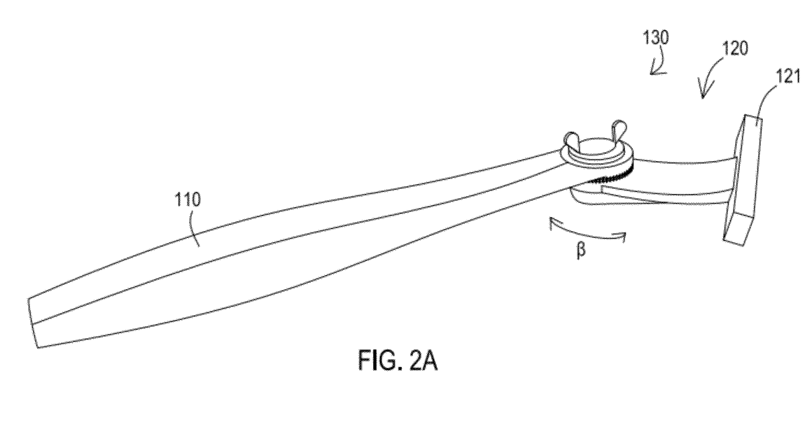

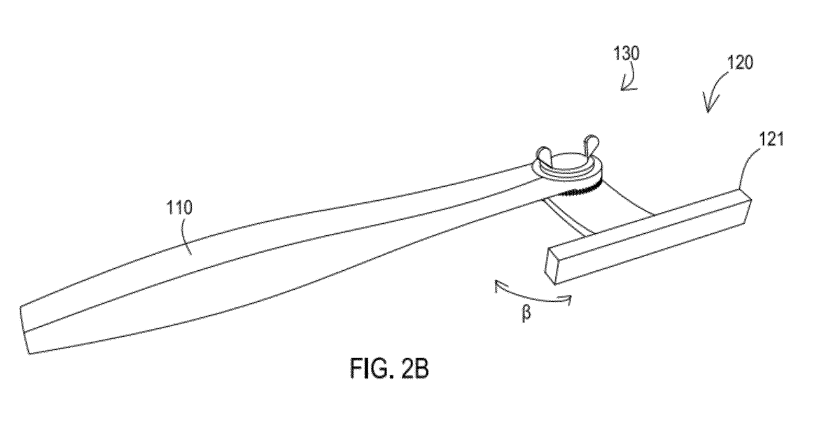

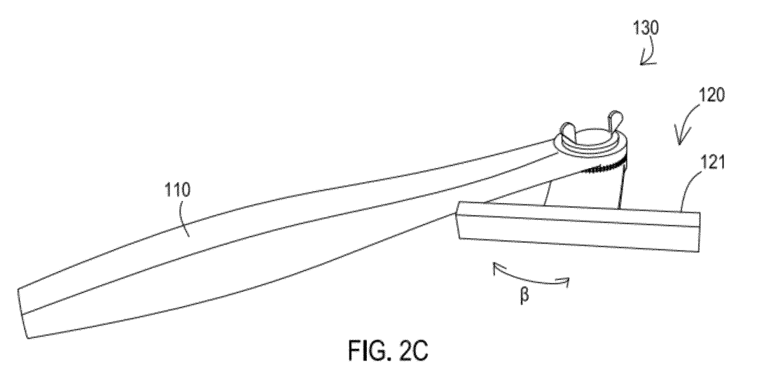

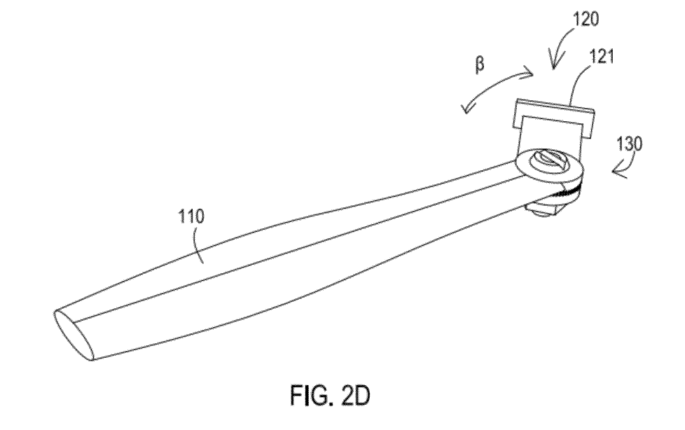

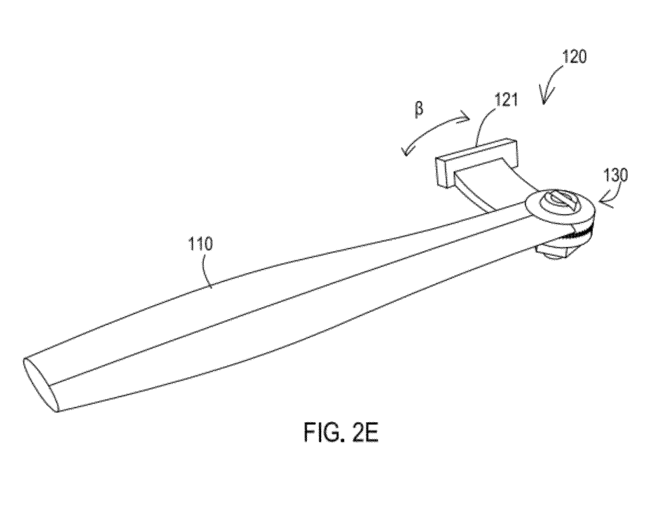

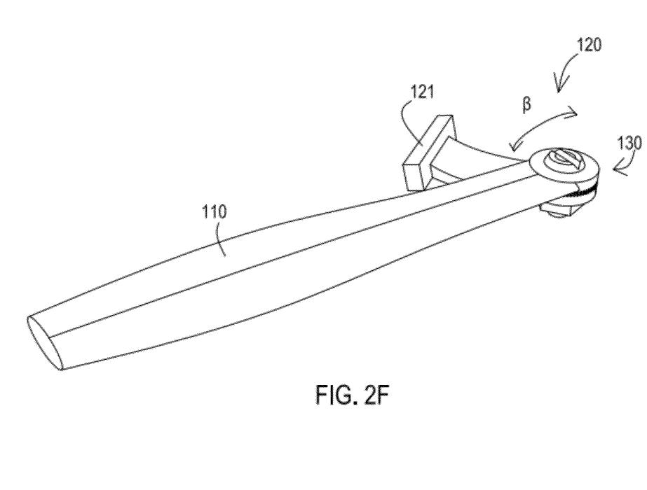

As shown in FIGS. 2A-2C, the angle β is adjustable between 0 degree and 360 degrees by rotatably adjusting one of the first and second engaging members 132 and 134 relative to the other of the first and second engaging members 132 and 134, and then tightening the screw member 136 and the nut 138 to lock the first engaging member 132 to the second engaging member 134 tightly.

For such a configuration of the razor 100, a user can easily and effectively shave unwanted hairs on the back of head, under the arms, the back of legs, the neck/face, and other areas without having to position the arm of the user at odd angles, thereby allowing the user to remove unwanted hair in a substantially easier fashion or create custom designs in the facial or scalp area or any other areas of the body.

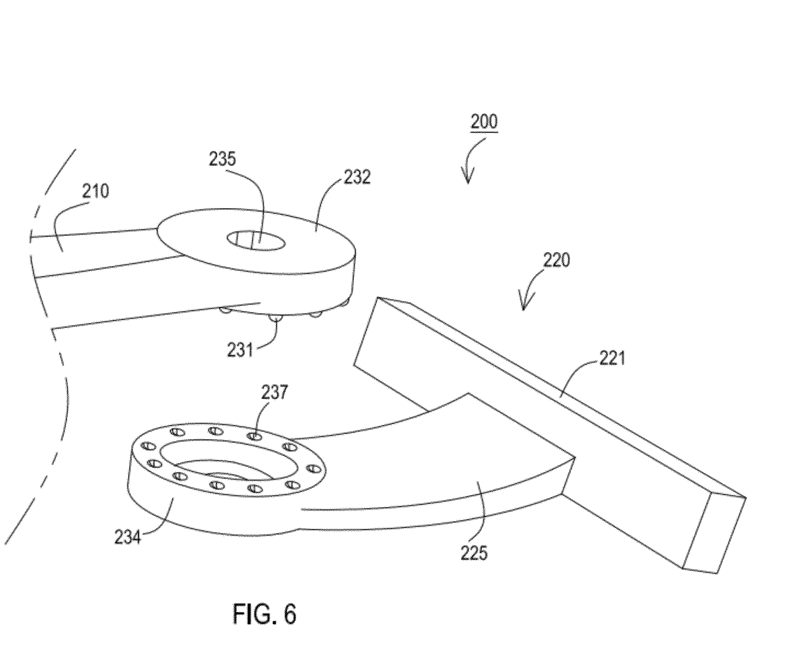

FIG. 6 shows schematically a partially perspective view of a razor 200 according to another embodiment of the present invention. The razor 200 is structurally and functionally similar to the razor 100 shown in FIGS. 1-5, except that the structural pattern 231 on the surface of the first engaging member 232 has a plurality of protrusions 231, while the structural pattern 237 on the surface of the second engaging member 234 has a plurality of recesses 237 complementarily corresponding to the plurality of protrusions 231 on the surface of the first engaging member 232. As assembled, the arm 225 of the razor head 220 is aligned with the handle 210 at a desired angle, β, and the surface of the first engaging member 232 is in substantial contact with the surface of the second engaging member 234, so that the protrusions 231 on the surface of the first engaging member 232 is complementarily received in the recesses 237 on the surface of the second engaging member 234, so as to prevent the first and second engaging members 232 and 234 from relatively moving when locked by a locking means such as a screw and corresponding nut or a spring.

In one embodiment of the present invention (not shown), the structural pattern on the surface of the first engaging member has a plurality of recesses, while the structural pattern on the surface of the second engaging member has a plurality of protrusions complementarily corresponding to the plurality of recesses on the surface of the first engaging member.

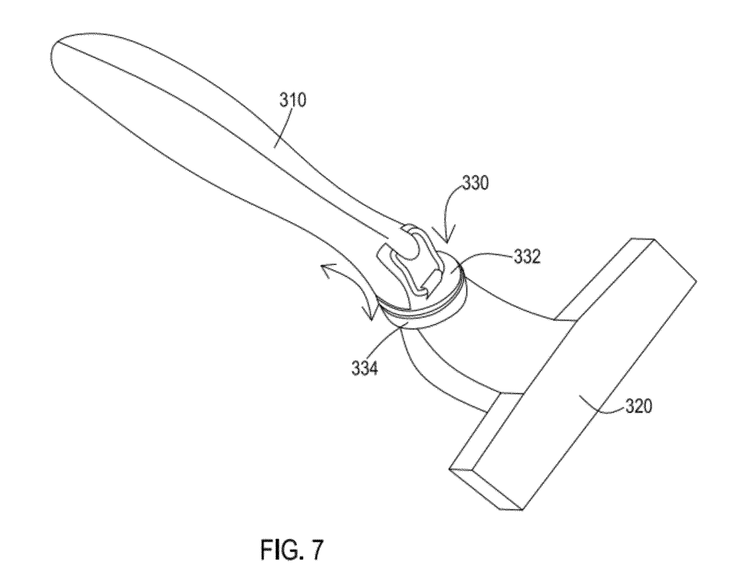

FIG. 7 shows schematically a perspective view of a razor 300 according to yet another embodiment of the present invention. In this example, the engaging mechanism 330 having a first engaging member 332 and a second engaging member 334 is formed individually. Each of the first and second engaging members 332 and 334 may have the same features as those disclosed above and shown in FIGS. 1-6.

As assembled, the first engaging member 332 is securely attached to one end of the handle 310, while the second engaging member 334 is securely attached to one end of the arm of the razor head 320. In use, the razor 300 functions same as the razors 100 and 200 do.

In sum, the present invention, among other things, recites a razor having a handle, a head with a cartridge, and an engaging mechanism for engaging the head with the handle, where the engaging mechanism is configured such that the head is adjustably aligned with the handle at any desired angle between 0-360 degrees.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A razor, comprising:
(a) a handle;
(b) a razor head; and
(c) an engaging mechanism having a first engaging member secured to the handle and a second engaging member secured to the razor head, each of the first and second engaging members having a surface and a structural pattern formed thereon, the structural pattern on the surface of the first engaging member being substantially complementary to the structural pattern on the surface of the second engaging member,
wherein, as assembled, the surface of the first engaging member is in substantial contact with the surface of the second engaging member such that the structural pattern on the surface of the first engaging member and the structural pattern on the surface of the second engaging member are complementarily and mutually engaged so as to lock the first engaging member to the second engaging member so that the razor head is aligned with the handle in a desired angle, β.

2. The razor of claim 1, wherein the angle β is adjustable between 0 degree and 360 degrees by rotatably adjusting one of the first and second engaging members relative to the other of the first and second engaging members.

3. The razor of claim 1, wherein each of the first and second engaging members of the engaging mechanism defines an opening in the center thereof.

4. The razor of claim 3, wherein the engaging mechanism further comprises a screw member placed between the first and second engaging members through the openings to urge the structural patterns on the surfaces of the first and second engaging members substantially in a complementary engagement with one another.

5. The razor of claim 1, wherein the structural pattern on the surface of the first engaging member comprises a plurality of protrusions, and the structural pattern on the surface of the second engaging member comprises a plurality of recesses complementarily corresponding to the plurality of protrusions on the surface of the first engaging member, and vice versus.

6. The razor of claim 1, wherein each of the structural patterns on the surfaces of the first and second engaging members comprises a plurality of ribs spatially and radially arranged to define a saw-tooth profile circumferentially, wherein the saw-tooth profile on the surface of the first engaging member is substantially complementary to the saw-tooth profile on the surface of the second member.

7. The razor of claim 3, wherein the engaging mechanism further comprises a spring member placed between the first and second engaging members through the openings to urge the structural patterns on the surfaces of the first and second engaging members substantially in a complementary engagement with one another.

8. The razor of claim 1, wherein the razor head comprises a razor cartridge body including one or more blades and an arm having a first end secured to the razor cartridge body and an opposite, second end secured to the second engaging member of the engaging mechanism.

9. The razor of claim 1, wherein the razor head comprises a razor cartridge body including one or more blades of ¼ inch length.

10. The razor of claim 1, wherein the razor head comprises a razor cartridge body including one or more blades of ⅜ inch length.

11. The razor of claim 1, wherein the razor head comprises a razor cartridge body including one or more blades of 1 inch length.

12. The razor of claim 8, wherein the handle and the first engaging member of the engaging mechanism are integrally formed, and the arm of the razor head and the second engaging member of the engaging mechanism are integrally formed.

13. A razor, comprising:
(a) a handle having a first engaging member formed in one end thereof; and
(b) a razor head having a razor cartridge body, a second engaging member and an arm formed between the razor cartridge body and the second engaging member,
wherein each of the first and second engaging members has a surface and a structural pattern formed thereon, wherein the structural pattern on the surface of the first engaging member is substantially complementary to the structural pattern on the surface of the second engaging member, and wherein, as assembled, the surface of the first engaging member is in substantial contact with the surface of the second engaging member such that the structural pattern on the surface of the first engaging member and the structural pattern on the surface of the second engaging member are complementarily and mutually engaged so as to lock the first engaging member to the second engaging member so that the arm of the razor head is aligned with the handle in a desired angle, β.

14. The razor of claim 13, wherein the angle β is adjustable between 0 degree and 360 degrees by rotatably adjusting one of the first and second engaging members relative to the other of the first and second engaging members.

15. The razor of claim 13, wherein each of the first and second engaging members defines an opening in the center thereof.

16. The razor of claim 13, wherein the razor head comprises a razor cartridge body including one or more blades of ¼ inch length.

17. The razor of claim 13, wherein the razor head comprises a razor cartridge body including one or more blades of ⅜ inch length.

18. The razor of claim 13, wherein the razor head comprises a razor cartridge body including one or more blades of 1 inch length.

19. The razor of claim 13, further comprising a spring member placed between the first and second engaging members through the openings to urge the structural patterns on the surfaces of the first and second engaging members substantially in a complementary engagement with one another.

20. The razor of claim 13, further comprising a screw member placed between the first and second engaging members through the openings to urge the structural patterns on the surfaces of the first and second engaging members substantially in a complementary engagement with one another.

21. The razor of claim 13, wherein the structural pattern on the surface of the first engaging member comprises a plurality of protrusions, and the structural pattern on the surface of the second engaging member comprises a plurality of recesses complementarily corresponding to the plurality of protrusions on the surface of the first engaging member, and vice versus.

22. The razor of claim 13, wherein each of the structural patterns on the surfaces of the first and second engaging members comprises a plurality of ribs spatially and radially arranged to define a saw-tooth profile circumferentially, wherein the saw-tooth profile on the surface of the first engaging member is substantially complementary to the saw-tooth profile on the surface of the second member.
